(19) United States
(12) Patent Application Publication
(10) Pub. No.: US 2009/0250397 A1
(43) Pub. Date: Oct. 8, 2009

(54) WATER SOFTENER WITH INTEGRATED WATER FILTRATION

(76) Inventors: Christopher Raymond Geisen, Louisville, KY (US); Michael Thomas Beyerle, Pewee Valley, KY (US); Mark Allen Banta, Crestwood, KY (US); Samuel Vincent DuPlessis, Louisville, KY (US); Norman Jacques Beulard, Louisville, KY (US); Daniel Ryan Capelle, Corydon, IN (US); Mark Anthony Copelli, Floyds Knobs, IN (US)

Correspondence Address: MERCHANT & GOULD GE CONSUMER & INDUSTRIAL, P.O. BOX 2903, MINNEAPOLIS, MN, 55402, US

(21) Appl. No.: 12/062,501

(22) Filed: Apr. 3, 2008

(51) Int. Cl. C02F 1/42; B01D 21/30; B01D 21/34; B01D 35/143; B01D 65/02; B01D 35/147; B01D 35/14; B01D 35/16

(52) U.S. Cl. 210/636; 210/198.1; 210/104; 210/85; 210/96.1; 210/130; 210/108; 210/142; 210/87; 210/687

(57) ABSTRACT

Systems and methods for filtering and softening water in combination are disclosed. The systems may include a water filtering system, having a water filter and a water softening system connected to the water filtering system. In addition, a controller may be connected to the water filtering system and the water softening system via wired or wireless connections. The methods may include filtering incoming water, monitoring the hardness of the incoming water, and softening the incoming water when the water hardness is above a maximum level. Furthermore, the performance of the water filtering system may be altered in response to the performance of the water softening system. In addition, the performance of the water softening system may be altered in response to the performance of the water filtering system.

### FIELD OF INVENTION

Embodiments of the present invention relate to water conditioning. More specifically, embodiments of the present invention relate to systems and methods for both filtering and softening water.

### BACKGROUND OF THE INVENTION

Water softeners and filters are used to remove solid particulate matter, tastes, odors, as well as mineral deposits that lead to staining and chalky buildups in sinks and bathtubs. Currently, there are no combination replaceable water filter and water softener systems available. If a consumer desires both filtered and softened water, they must purchase a filtering system and a softening system. These two systems are separate and distinct from one another. In other words, the water filter and water softener are “stand alone” components and removing either component will not significantly affect the other's performance. In addition, the existing water filter and water softener systems do not provide a central feedback system to a homeowner when maintenance may be required. Furthermore, the current water filter and water softener systems are not programmable and do not monitor water quality.

There exists a need for a hybrid water treatment system that is configured for user programming and allows for interaction between the filtering and softening components of such a hybrid system. There also exists a need for a hybrid water treatment system that has the ability to diagnose various problems as well as advise a user that maintenance may be needed. Furthermore, there exists a need for a hybrid water treatment system that may adjust operation for varying environmental conditions and water quality.

### BRIEF DESCRIPTION OF THE INVENTION

Consistent with embodiments of the present invention, a combination water filter-water softener system includes a water filtering system and a water softening system connected to the water filtering system. In addition, a controller may be connected to the water filtering system and the water softening system via wired or wireless connections. The controller may be configured to alter the performance of the water filtering system based on the performance of the water softening system and/or the performance of the water softening system based on the performance of the water filtering system.

Still consistent with embodiments of the present invention, methods for filtering and softening water include filtering incoming water and monitoring the hardness of incoming water. The method may further include softening the incoming water when the water hardness is above a maximum hardness threshold. Furthermore, the performance of the water filtering system may be altered based on the performance of the water softening system; and the performance of the water softening system may be altered based on the performance of the water filtering system.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts a front view of a hybrid water treatment system having a movable panel in an open position consistent with embodiments of the invention;

FIG. 2 depicts a front view of a hybrid water treatment system having a movable panel in a closed position consistent with embodiments of the invention;

FIG. 3 depicts a side view of a hybrid water treatment system consistent with embodiments of the invention;

FIG. 4 depicts a controller interface consistent with embodiments of the invention; and

FIG. 5 depicts a filter connection consistent with embodiments of the invention.

### GENERAL DESCRIPTION

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Furthermore, reference to a single item may mean a single item or a plurality of items, just as reference to a plurality of items may mean a single item. Moreover, use of the term “and” when incorporated into a list is intended to imply that all the elements of the list, a single item of the list, or any combination of items in the list has been contemplated. What is more, throughout this specification the terms “performance” and “operation” may be use interchangeably.

Embodiments of the present invention utilize a controller programmed to control the hybrid water treatment system that facilitates control of water filtering and water softening. The controller may be programmed to have preset modes of operation. In addition, the controller may be programmed to interpret water quality readings and adjust operation of the hybrid water treatment system based on the water quality readings. Furthermore, the controller may be configured to monitor usage levels (e.g. average gallons used per day, week, month, etc). Moreover, the hybrid water treatment system may be configured to diagnose when the hybrid water treatment system may be malfunctioning and/or need service.

### DETAILED DESCRIPTION

Various embodiments are described more fully below with reference to the accompanying drawings, which form a part hereof, and which show specific embodiments of the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

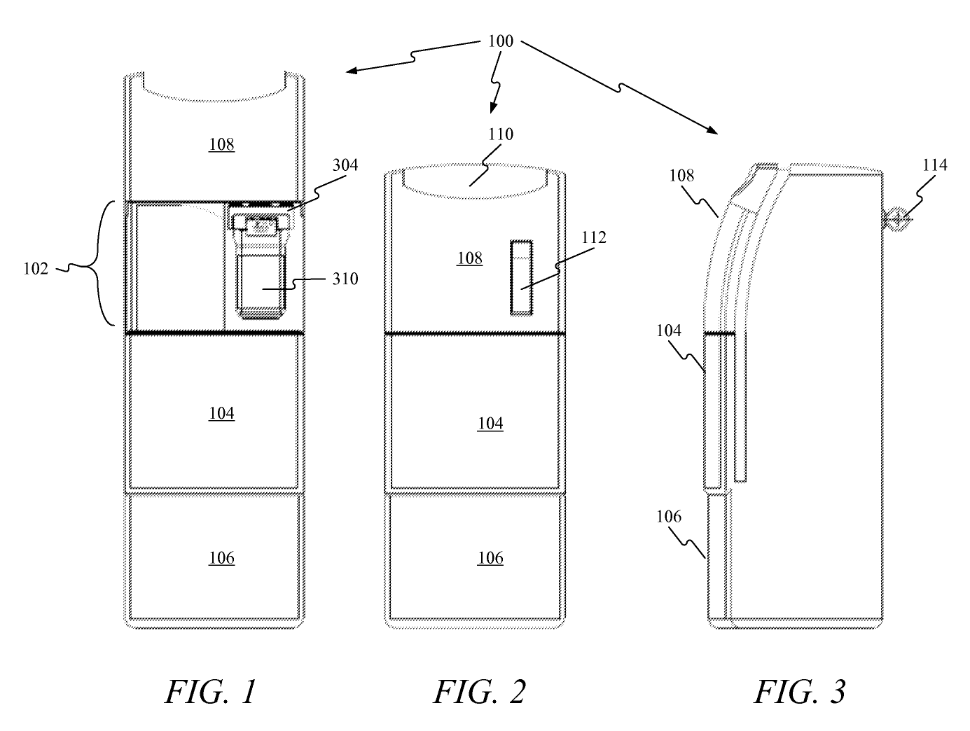

Referring now to the figures, FIG. 1, FIG. 2 and FIG. 3 depicts front views and a side view of a hybrid water treatment system 100. As illustrated in FIG. 1, hybrid water treatment system 100 includes a water filter component 102, a water softening component 104, a support pedestal 106 and a movable panel 108. As illustrated in FIG. 2, hybrid water treatment system 100 may include a controller interface 110 coupled to a controller (not shown). The controller is coupled to water filter component 102 and water softening component 104. In addition, as illustrated in FIG. 3, hybrid water treatment system 100 may include dial 114 for use in adjusting the water hardness setting.

During operation of hybrid water treatment system 100, inflow water may enter hybrid water treatment system 100 and may flow, first through water filter component 102 at which point contaminants such as chlorine and particulate matter may be removed from the inflow water. After flowing through water filter component 102 the water may then flow through water softening component 104 at which time the hardness of the water may be adjusted to a preset level. The preset level may be set by a user, a calculated level depending on the hardness of the inflow water, or a preset level set during manufacturing. Additionally, a hardness sensor may be used in conjunction with the controller to monitor and adjust hardness as it enter and exits hybrid water treatment system 100.

Aspects of the invention include having a single controller that monitors and adjust operations of both filter component 102 and softening component 104 simultaneously. For instance, the controller may adjust the operation of filter component 102 in response to feedback provided by the hardness sensor. In addition, the controller may adjust the operation of softening component 104 in response to feedback provided by contaminate level sensor.

For example, excessive particulate matter may interfere with or shorten the operation of softening component 104. Consistent with embodiments of the invention, the controller may monitor the contaminate level of water leaving filter component 102 or monitor the contaminate level of water upstream of the filter component and when the contaminate level exceeds a predetermined value, the controller may cause all or a portion of the water entering softening component 104 to bypass softening component 104. By bypassing all or a portion of the water entering softening component 104 the capacity and reliability of the softening component may be preserved. For example, if the sediment filter capacity is exceeded, bypassing the softener can prevent the resin bed from contamination with sediment. In addition, if a chlorine filter capacity has been exceeded, bypassing the softener could protect the resin from chlorine attack and extend the useful life of the resin. Further, when the softener is bypassed and not in use, salts used in softening water may be preserved.

Another example of the controller altering hybrid water treatment system 100 operation may include causing all or a portion of water entering filter component 102 to bypass filter component 102 when softening component 104 is unable to soften the water. For instance, the salts used to soften the water may be depleted and in response to this condition, the controller may cause all or a portion of the water entering softening component 104 to bypass filtering component 102. By causing water to bypass filter component 102 the lifespan of the filter may be prolonged. For example, the performance and capacity of certain filter element types may be sensitive to the hardness of the water. Hard water usually includes the following metals, calcium (Ca²⁺), magnesium (Mg²⁺) ions. A filter element may be specifically designed to reduce other metal contaminants such as lead or arsenic ions. These contaminants may also be present in hard water. In order for a specific filter element to properly remove metal contaminants such as lead or arsenic ions, the water should be soft. Hard water will deplete the filter media for removing specific contaminants such as lead or arsenic and reduce or eliminate the effectiveness of said filter elements. The controller can sense with a hardness sensor the softener is no longer producing soft water and can bypass the filter elements. Also, the controller can sense if the salt is depleted. When the softener has been regenerated or restored to proper operation, the controller can stop bypassing the filter media so the specific contaminants such as lead and arsenic ions can be removed.

During operation hybrid water treatment system 100 may monitor a salt or resin level, a quantity of water used, a time remaining until maintenance may be required, and other operating parameters. These parameters may be monitored using various sensors connected to a controller and the parameters may be displayed on controller interface 110. While controller interface 110 is shown in FIG. 2 located on hybrid water treatment system 100, it is contemplated that controller interface 110 may be located a substantial distance from hybrid water treatment system 100. A substantial distance is intended to imply that controller interface 110 is separate from hybrid water treatment system 100. For example, hybrid water treatment system 100 may be located in a mechanical room or the basement of a home and controller interface 110 may be located in another room in the home, such as the kitchen, bathroom, or any other convenient location where the user may control hybrid water treatment system 100 operations without having to be in the physical presence of hybrid water treatment system 100.

It is contemplated that controller interface 110 may be connected to hybrid water treatment system 100 via a wired or wireless connection. When controller interface 110 is operatively connected to hybrid water treatment system 100 via a wireless connection, both the controller and hybrid water treatment system 100 may be configured to monitor a signal strength. By monitoring the signal strength either the controller and/or hybrid water treatment system 100 may alert a user when communications between hybrid water treatment system 100 and controller interface 110 may be inoperable.

During hybrid water treatment system 100 operation the controller may be configured to adjust the output water hardness based on the monitored hardness of the inflowing water. In various aspect of the invention, the controller may be configured to adjust the hardness of outlet water based on percentages. For example, the controller may be configured to reduce the hardness of incoming waters by a preset percentage, for example ten percent. In addition, hybrid water treatment system 100 may be configured to increase the water hardness. Pure water is corrosive to plumbing; therefore, hybrid water treatment system 100 may increase the hardness of out flowing water when the inlet water hardness level monitored is below a threshold level that is preset and may be modified via the controller and controller interface 110.

Furthermore, hybrid water treatment system 100 may adjust water hardness so that it is equivalent to a preset level. For example, hybrid water treatment system 100 may be configured to adjust the hardness of inflow water to 3 grains. Hybrid water treatment system 100 may also be configured to adjust to water hardness such that the water harness may fluctuate between a preset range or “operating range” (e.g. <1 grain or 1-3 grains). The operating range may be preset during manufacturing, programmed by a user, and be part of a programmed routine.

Water softening system 104's operation may be configured via controller interface 110 to be a self-cleaning system. For example, every night or every month, and other time periods, water softening component 104 may run a purge cycle in which case the system may be cleaned. In addition, self-cleaning may include back flushing water softening component 104 when water softening component 104 is unable to soften the incoming water to a level below the maximum hardness.

The controller may also be reprogrammable. The reprogramming of the controller may be done by a user and a service person. For example, during manufacturing, the controller may be loaded with preprogrammed routines such as the automatic cleaning cycle and desired water hardness, after the user has received hybrid water treatment system 100, the user may decide to only have the cleaning cycle run every month versus every week and the desired hardness to be “X” vs. “Y”. Having a reprogrammable controller allows for greater flexibility and for users to customize hybrid water treatment system 100 operations based upon user preferences and water quality demands.

In addition, the controller may also be preprogrammed with various preset programs including but not limited to a well program and a municipality program. In various aspects of the invention, a well program may indicate that the inflow water is from a well system and therefore may require additional treatment and monitoring (i.e. continuous monitoring) of inflow water quality as well as outflow water quality. Well systems may include wells, streams, river, lakes, and other sources above and below ground water supplies. When operating in “well mode” the controller may be programmed such that hybrid water treatment system 100 operations may shorten the active time between replacing of the filter 310 to account for what may be a more particulate contaminated water.

In various aspects of the invention, a municipality program may indicate that the inflow water is from a municipal system such as a city, county, or state controlled water treatment facility and therefore may require less treatment and monitoring (i.e. periodic monitoring) as opposed to well systems or other water supplies. In addition, there may be multiple “municipality modes.” Certain municipalities may produce water with more or less hardness then other municipalities, therefore the controller may be programmed such that the user may select from among a plurality of various municipality settings. For example, Indianapolis, Ind. municipal water is generally harder than Atlanta, Ga. municipal water, therefore the controller may be programmed with specific US city municipalities. As a further example, municipal water in Europe is generally harder than municipal water in the United States. Therefore the controller may be programmed with “United States” and “Europe” settings.

Other preset modes may be programmed as well. For example, the controller may be programmed with a “lawn care mode.” Consistent with embodiments of the invention, operation in lawn care mode may include the user providing a time period when a lawn sprinkler system is set to operate (e.g. from 4:00 AM to 5:00 AM) and may include receiving an indication from a home automation system that a lawn sprinkler system has been activated. While the lawn sprinkler system is in use, the controller may activate the automatic bypass system 304 such that resources (e.g. filter usage and water softening salts) are not wasted treating water used for lawn maintenance. Still consistent with embodiments of the present invention, when the lawn sprinkler system is in use, the control may alter the hardness level from “X” grains to “Y” grains.

Hybrid water treatment system 100 may also include a dial 114 usable to adjust the hardness. Consistent with embodiments of the invention, the user may adjust the desired water hardness by turning dial 114. For example, the user may rotate dial 114 to set the water hardness at “X” grains. In addition, hybrid water treatment system 100 may be configured such that the user may rotate dial 114 to set an operating range of water hardness. For example, dial 114 may include two dials; one for indicating the upper range of water hardness and the second for indicating the lower range of water hardness. Furthermore, the hybrid water treatment system 100 may be configured such that dial 114 indicates the midpoint of a water hardness range. For example, dial 114 may be set to “X” grains and hybrid water treatment system 100 may be configured to maintain the water hardness at “X” grains±“Y” grains. It is contemplated that other forms of water hardness tolerances may be used (i.e. percentages, standard deviation, etc.). For example an upper range of hardness may be set by the incoming water hardness. The maximum hardness that may be that of the incoming water hardness

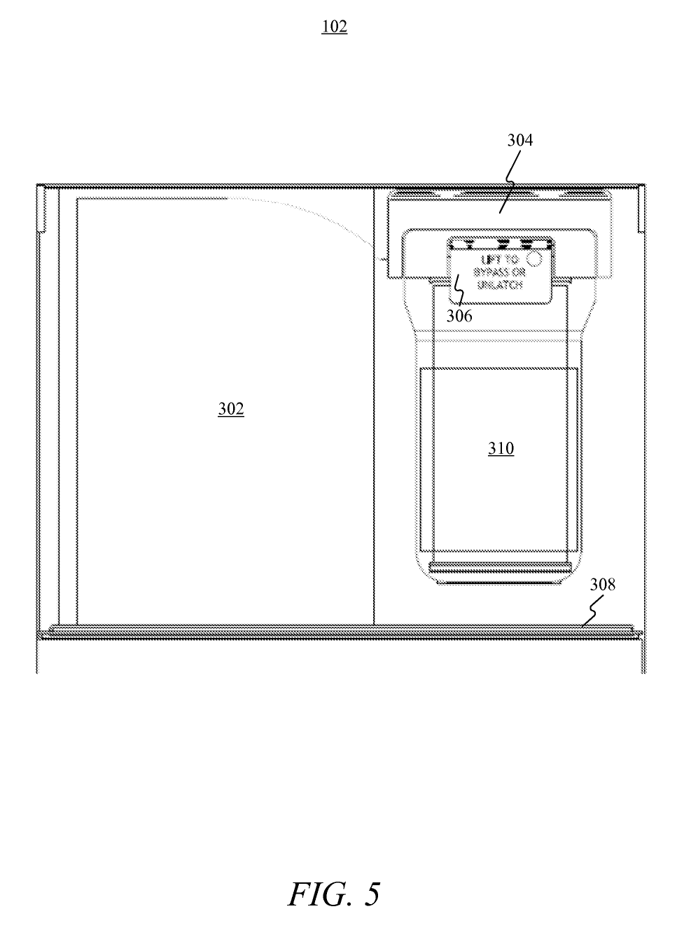

The water filtering component 102 may also be configured to have an automatic bypass system 304 as illustrated in FIG. 5. The automatic bypass system 304 may be configured such that when the water filter 310 is removed from hybrid water treatment system 100 water may continue to flow to water softening element 104 and throughout the residence uninterrupted. For example, during maintenance, the user may remove water filter 310 causing the automatic bypass system 304 to automatically reroute water past the water filtering component 102 to water softening element 104, whereby water service throughout the residence is not be interrupted during maintenance. Automatic bypass system 304 may be activated by a cam system. For example, rotating water filter 310 may cause a cam to rotation thereby activating automatic bypass system 304.

Water filtering component 102 may also be “toolless.” Toolless is intended to imply water filtering component 102 may be configured such that the user may remove water filter 310 without tools. For example, the water filtering component 102 may be configured such that water filter 310 may be removed by a user when the user grips the water filter 310 and turns the water filter a quarter turn.

Additionally, the controller may be programmed to recognize a smart filter. A smart filter may contain methods for self-identification such as an RFID tag and an electrical contact which when connected to water filter component 102 may indicate the type, capacity, brand, model, and other water filter characteristics such that the controller may determine the type of filter being used. For example, filter 310 may be an RFID tag which indicates that filter 310 is a 10,000 gallon filter. Upon installation, the controller may read the RFID tag and monitor the amount of water passing through filter 310. When 10,000 gallons of water usage has occurred, the controller may alert the user that the filter needs replacing. Additionally, filter 310 may be a 50,000 gallon filter or other capacity filter, which, at the time of installation in hybrid water treatment system 100, the controller may automatically recognize the type and operational parameters of filter 310 thereby alleviating the user from having to reprogram hybrid water treatment system 100.

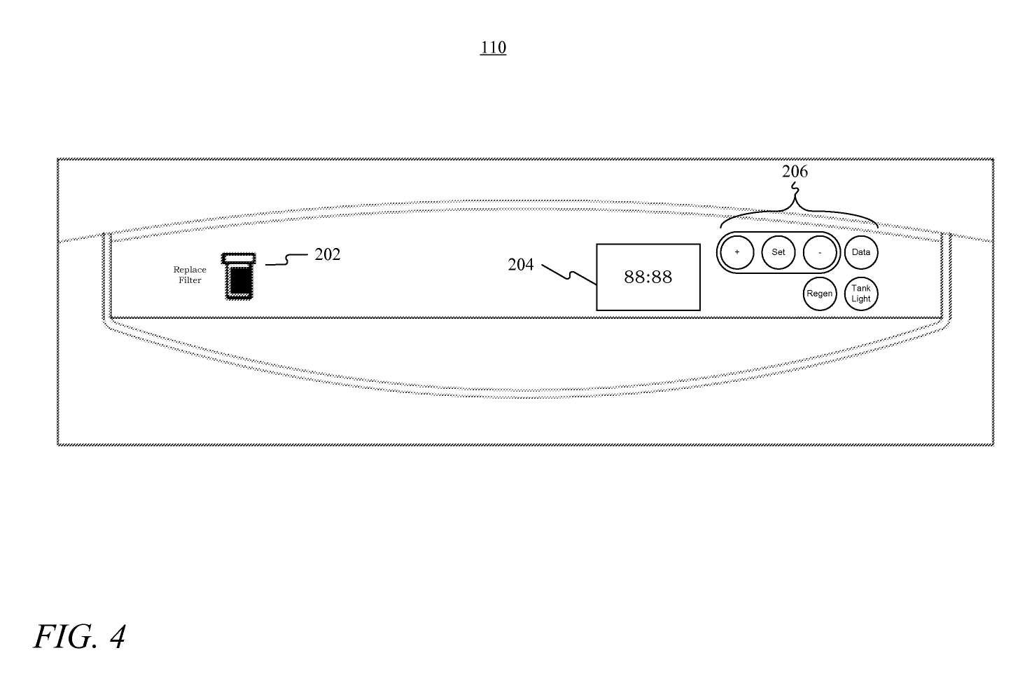

Referring now to FIG. 4, FIG. 4 depicts controller interface 110 consistent with embodiments of the invention. Controller interface 110 may include a filter replacement indictor 202, a display 204 and various control buttons 206. While not shown, as described above, controller interface 110 may include a signal strength display and other indicators. Furthermore, controller interface 110 may include audible indicators to convey information to the user.

Filter replacement indicator 202 may be configured to alert the user of the level of usage of filter 310. For example, filter replacement indicator 202 may be configured such that after 25% of filter usage, three of four lights may glow and these lights may glow in green. Once 75% of the filter has been used, only one of the filter indicator lights may glow and this light may glow in yellow. At the end of filter 310's useful life all four of the indicator lights may flash red to indicate that filter 310 may need replacement. In various aspects of the invention, indication that filter 310 may need replacing may be in the form monitoring the pressure drop across filter 310. The varying degrees of pressure drop may be correlated to filter dirtiness. For example, a pressure drop greater than 12.9 mmHg (0.25 psi) pressure drop may indicate filter 310 is clogged. Should the pressure drop exceed a predetermined maximum pressure drop the controller may notify the user filter 310 needs changing. The predetermined maximum pressure drop may be set during manufacturing, by a service technician, and the end user.

In addition to changing filter 310, the controller may be configured to allow filter 310 to be backflushed. For example, when the controller recognized that a predetermined number of gallons of water have passed through the filter, the controller may active a valving system to cause water to flow through filter 310 in a reverse direction to clean or regenerate filter. It is further contemplated that backflushing filter 310 may be performed in conjunction with backflushing softening component 104 as described above. 310

It is contemplated that other forms of indication may be used to draw the user's attention to previously defined usage levels or various maintenance issues. For example, the user's attention may be drawn to instances when the filter component is being bypassed as a result of the detection of insufficient softening capability (e.g. salts used to soften water have been depleted) In another example, the user's attention may be drawn to instances when the softener component is being bypassed as a result of the detection of insufficient filtering capability (e.g. the filter is dirty or clogged).] By way of example and not limitation, other indication methods may include, greater intensity lighting, extinguishing of certain lights, various patterns of flashing lights (e.g. frequency, light combinations, and physical patterns). In addition, hybrid water treatment system 100 and controller interface 110 may produce an audible indicator to alert the user.

As with lighting, the audible indicator may vary with intensity, volume, pattern, etc. to indicate various issues which may require the user's attention. For example, hybrid water treatment system 100 and controller interface 110 may be configured to produce a very loud noise for problems which may require immediate attention (i.e. water leak, clogged piping, high pressures, etc.). For problems which don't require immediate attention, hybrid water treatment system 100 and controller interface 110 may be configured to produce low volume indicators. For example, if high pressures are detected in hybrid water treatment system 100, controller interface 110 and hybrid water treatment system 100 may produce a loud constant noise audible through the user's home. If filter 310 needs replacing, hybrid water treatment system 100 and controller interface 110 may initiate low volume beeping noises only audible when a person is in the presence of hybrid water treatment system 100 and controller interface 110.

Consistent with embodiments of the invention, controller interface 110 may be a virtual controller interface. For example, hybrid water treatment system 100 may be connected to a home automation system, the internet, and a phone line such that controller interface 110 is located/accessible via the user's computer, a web-based interface, and a telephone. Hybrid water treatment system 100 and the home automation system may be configured to alert the user while the user is away that an error has occurred.

For example, if the hybrid water treatment system 100 is installed in a secondary residence that is not used on a consistent basis, if the temperature within the residence drops below a certain level and a pipe were to burst, the hybrid water treatment system 100 and the home automation system may detect a significant increase in water flow as compared to the previous day's flow and in response send the user an indication that there may be a malfunction or some other abnormal operating condition. The indication transmitted may be a plurality of different messages depending on the increase in water flow. The message may range from a need to check to make sure everything is okay to an emergency indicator advising a need to send a maintenance crew immediately. By way of example and not limitation, the indication may be in the form of an e-mail, a phone call from a monitoring service, a pre-recorded message from hybrid water treatment system 100. Furthermore, hybrid water treatment system 100, the home automation system, and the telephone may be used to control operation of hybrid water treatment system 100. For example, hybrid water treatment system 100, the home automation system, and the telephone may be used to shut down hybrid water treatment system 100.

Controller interface 110 may include display 204 which may display the time, the water hardness, gallons used, and other operating parameters associated with the hybrid water treatment system 100 operations. Additionally, the display 204 may provide instructions and other indicators to facilitate user programming. For example, the display 204 may provide step-by-step instructions and other prompts that the user may follow to program hybrid water treatment system 100. For instance, if the user desires to change the water hardness the user may press one of control buttons 206, at which time the current water hardness setting may be displayed on display 204. The user may then acknowledge the current water hardness setting by pressing either the same or a different control button 206 at which time display 204 may prompt the user to set and confirm the new hardness level engaging the same or a different one or more of control buttons 206.

Turning now to FIG. 5, FIG. 5 depicts a water filtering component consistent with embodiments of the invention. Water filtering component 102 comprises water filter 310 connected to an automatic bypass system 304 having a release latch 306, and a spill catch area 308. Spill catch area 308 is for use in containing water spillage that may occur during replacement water filter 310. In addition, the water filter area may include a space for a “quick reference guide” as indicated by reference numeral 302.

The quick reference guide may be used to provide the user with instruction for the most common features associated with hybrid water treatment system 100. Furthermore, the quick reference guide may provide the user with quick reference instructions for reprogramming the controller and interpretations of both visual and audible alters. For example, the quick reference guide may convey to the user that a particular flashing light pattern and a particular audible sound means the salts need replenishing, etc.

Filter 310 may include a clear filter housing. This clear filter housing may allow the user to visually inspect filter 310, allowing the user to visually confirm that water is able to flow through filter 310 (i.e. filter 310 is not clogged), filter 310 is not overly dirty, (i.e. a filtering sensor is incorrectly indicating clean water when filter 310 is obviously dirty.) Further more, hybrid water treatment system 100's movable panel 108 may contain a window 112 to allow the user to visually inspect filter 310 without having to raise movable panel 108.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system for filtering and softening water comprising:
a water filter;
a water softener operatively connected to the water filter; and
a controller operatively connected to the water filter and the water softener, the controller configured to alter at least one of the following:
the performance of the water filter based on the performance of the water softener, and
the performance of the water softener based on the performance of the water filter.

2. The system of claim 1, wherein the controller is further configured to monitor at least one of the following: a salt level, a quantity of water used, and a time remaining until maintenance is required.

3. The system of claim 1, wherein the controller is located a substantial distance from the water filter and the water softener.

4. The system of claim 3, wherein the controller is further configured to:
communicate with the water filter and the water softener via wireless communications;
monitor a signal strength of the wireless communications; and
provide a notification when the signal strength is below a minimum signal strength.

5. The system of claim 1, wherein the controller is further configured to adjust a water hardness based upon a monitored water hardness.

6. The system of claim 1, wherein the water filter comprises an automatic bypass system.

7. The system of claim 1, wherein the water filter is configured to facilitate changing the water filter without the use of tools.

8. The system of claim 1, wherein the water softening system is configured to self-clean.

9. The system of claim 1, wherein the controller is configured to be reprogrammable by a user.

10. The system of claim 1 further comprising a sensor configured to monitor a contaminate level of the water, wherein the controller is configured to cause at least a portion of the water to bypass the softener component if the contaminate level exceeds a predetermined level.

11. The system of claim 1 further comprising a sensor configured to monitor a hardness of the water, wherein the controller is configured to cause at least a portion of the water to bypass the filter component if the hardness level exceeds a predetermined level.

12. The system of claim 1 further comprising a sensor to monitor an amount of softening salt in the water softener of the softener, wherein the controller is configured to cause at least a portion of the water to bypass the filter component if the softening salt is depleted.

13. A method for filtering and softening water, the method comprising:
filtering incoming water;
monitoring the hardness of the incoming water;
softening the incoming water when the hardness of the incoming water is above a threshold level; and
altering at least one of the following:
the performance of a water filtering system in response to the performance of a water softening system, and
the performance of the water softening system in response to the performance of the water filtering system.

14. The method of claim 13, further comprising monitoring at least one of the following: a salt level, a quantity of water used, and a time remaining until maintenance is required.

15. The method of claim 13, further comprising:
tracking a filter contaminate level; and
providing an indication that a filter needs changing, the indication being based upon a comparison of the filter contaminate level to a maximum contaminate level.

16. The method of claim 13, further comprising:
tracking the quantity of water during a time interval that passes through at least one of the following:
the water filtering system; and
the water softening system;
providing an indication that a filter needs changing in response to the quantity of water being greater than a filter rating.

17. The method of claim 13, further comprising:
monitoring a signal strength, the signal strength being an indicator of a controller located a substantial distance from a water filtering system and a water softening system being able to communicate with the water filtering system and the water softener system; and
providing an indication when the signal strength is below a minimum signal strength.

18. The method of claim 13, further comprising:
back flushing the water softening system when the water softening system is unable to soften the incoming water to a level below the maximum hardness.

19. The method of claim 13 further comprising:
monitor a contaminate level of the water; and
causing at least a portion of the water to bypass the softener component if the contaminate level exceeds a predetermined level.

20. The method of claim 13 further comprising:
monitoring a hardness of the water; and
causing at least a portion of the water to bypass the filter component if the hardness level exceeds a predetermined level.

21. The method of claim 13 further comprising:
monitoring an amount of softening salt in the water softener of the softener; and
causing at least a portion of the water to bypass the filter component if the softening salt is depleted.

22. An apparatus for controlling operation of a water filtering system and a water softening system, the apparatus comprising:
a controller configured to be connected to a water filtering system and a water softening system, to controller configured to:
simultaneously monitor the operation of a water filtering system and a water softening system;
alter the operation of the water filtering system and the water softening system in response to data representative of the monitored operation of at least one of the following: the water filtering system and the water softener system.

23. The apparatus of claim 22, wherein the controller is further configured to recognize a smart filter.

24. The apparatus of claim 23, wherein the controller is further configured to reprogram in response to data received from the smart filter.

25. The apparatus of claim 22, wherein the controller is further configured to activate an automatic bypass system upon receiving an indication of at least one of the following: a filter has been removed from the water filtering system, the water filtering system has a malfunction, and the water softening system has a malfunction.

26. The apparatus of claim 22, wherein the controller is configured to receive at least one of the following: a custom program created by a user, a well program, a municipality program, and a lawn care mode.

27. The apparatus of claim 22, wherein the controller is configured to:
monitor a contaminate level of the water; and
cause at least a portion of the water to bypass the softener component if the contaminate level exceeds a predetermined level.

28. The apparatus of claim 22, wherein the controller is configured to:
monitor a hardness of the water; and
cause at least a portion of the water to bypass the filter component if the hardness level exceeds a predetermined level.

29. The apparatus of claim 22, wherein the controller is configured to:
monitor an amount of softening salt in the water softener of the softener, and
cause at least a portion of the water to bypass the filter component if the softening salt is depleted.
